(19) United States
(12) Patent Application Publication
(10) Pub. No.: US 2026/0317460 A1
(43) Pub. Date: Oct. 15, 2026

(54) ETHYLENE COPOLYMER

(71) Applicant: Innospec Leuna GMBH, Leuna (DE)

(72) Inventors: Niklas LUCHT, Leipzig (DE); Winfried HOMMEL, Leipzig (DE); Christoph BORNSCHEIN, Leipzig (DE); Gunter HOFFMANN, Bopfingen (DE); Konrad OTTO, Halle/Saale (DE); Dietrich von der WENSE, Weimar (DE)

(21) Appl. No.: 19/101,149

(22) PCT Filed: Aug. 1, 2023
(86) PCT No.: PCT/EP2023/071312

§ 371 Date: Feb. 4, 2025

(30) Foreign Application Priority Data
Aug. 8, 2022 (GB) 2211548.9

(51) Int. Cl. C08F 210/16; C08F 2/01; C08K 5/14

(52) U.S. Cl. CPC C08F 210/16; C08F 2/01; C08F 2400/04; C08K 5/14

(57) ABSTRACT

An ethylene/alpha-olefin copolymer wax having a density of 0.91 g/cm³ or less as measured at 20° C. according to DIN EN ISO 1183, Part C.

### FIELD OF THE INVENTION

The present invention relates to a low density ethylene/alpha-olefin copolymer wax and to a process for preparing such a copolymer wax.

### BACKGROUND

Ethylene copolymer waxes are well known and have a variety of uses, for example as lubricants in plastics processing, as wetting and dispersing agents in masterbatches or as surface modifying agents in coatings and printing inks. Additionally, copolymers between ethylene and other vinyl co-monomers are known with wax-like character. When waxes with relatively low melting points and density are required, ethylene vinyl acetate (EVA) copolymers are often used, but these copolymers are polar and thermally unstable compared to polyethylene waxes.

There is therefore a need for non-polar, low density ethylene copolymers that provide desirable properties, including thermal stability, and for processes for preparing these.

### SUMMARY

According to a first aspect of the present invention there is provided an ethylene/alpha-olefin copolymer wax having a density of 0.91 g/cm³ or less as measured at 20° C. according to DIN EN ISO 1183, Part C.

According to a second aspect of the present invention, there is provided a process for preparing an ethylene/alpha-olefin copolymer wax having a density of 0.91 g/cm³ or less as measured at 20° C. according to DIN EN ISO 1183, Part C, comprising contacting the ethylene and the alpha-olefin under polymerization conditions at a temperature of from 220 to 290° C. and a pressure of at least 130 MPa.

### DETAILED DESCRIPTION

Unless otherwise stated, the following terms used in the specification and claims have the meanings set out below.

As used in the specification and the appended claims, the singular forms “a”, “an,” and “the” include both singular and plural referents unless the context clearly dictates otherwise.

Throughout this specification, the term “comprising” or “comprises” means including the component(s) specified but not to the exclusion of the presence of other components. The term “consisting essentially of” or “consists essentially of” means including the components specified but excluding other components except for components added for a purpose other than achieving the technical effect of the invention. The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and also may also be taken to include the meaning “consists of” or “consisting of”.

As used herein, unless otherwise expressly specified, all numbers such as those expressing values, ranges, amounts of percentages may be read as if prefaced by the word “about”, even if the term does not expressly appear.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.70 and 3.80, when referring to, for example, measurements). The recitation of end points also includes the end point values themselves (e.g. from 1.0 to 5.0 includes both 1.0 and 5.0). Any numerical range recited herein is intended to include all sub-ranges subsumed therein.

The optional features set out herein may be used either individually or in combination with each other where appropriate and particularly in the combinations as set out in the accompanying claims. The optional features for each exemplary aspect of the invention, as set out herein are also applicable to any other aspects or exemplary aspects of the invention, where appropriate. In other words, the skilled person reading this specification should consider the optional features for each aspect or embodiment of the invention as interchangeable and combinable between different aspects of the invention.

As used herein, the term “and/or,” when used in a list of two or more items, means that any one of the listed items can be employed by itself or any combination of two or more of the listed items can be employed. For example, if a list is described as comprising group A, B, and/or C, the list can comprise A alone; B alone; C alone; A and B in combination; A and C in combination, B and C in combination; or A, B, and C in combination.

According to a first aspect of the present invention there is provided an ethylene/alpha-olefin copolymer wax having a density of 0.91 g/cm³ or less as measured at 20° C. according to DIN EN ISO 1183, Part C.

The term “ethylene/alpha-olefin copolymer” would be well understood by a person skilled in the art to mean a copolymer comprising units of ethylene and units of an alpha-olefin. The copolymer may be in the form of an alternating copolymer, a periodic copolymer or a random copolymer. Suitably, the copolymer is a random copolymer. The copolymer may be a block copolymer, wherein the blocks of ethylene and the blocks of alpha-olefin may be dimers, oligomers or polymers. The copolymer may be a linear or a branched copolymer. Suitably, the copolymer is a branched copolymer. In other words, suitably the copolymer is non-linear.

The copolymer may be a branched copolymer and may comprise short chain and long chain branching.

References herein to “waxes” are intended to have their ordinary meaning in the art and would be well understood by persons skilled in the art. A wax is able to form a viscous liquid when melted, whereas a traditional polymer does not. For example a wax may be defined as a material for which a melt flow index value cannot be measured.

The ethylene/alpha-olefin copolymer wax has a density of 0.91 g/cm³ or less as measured at 20° C. according to DIN EN ISO 1183, Part C. A copolymer wax having such a density is considered to be a low density copolymer wax.

Suitably, the ethylene/alpha-olefin copolymer wax of the present invention has a density from 0.87 to 0.91 g/cm³, such as from 0.87 to 0.90 g/cm³, as measured at 20° C. according to DIN EN ISO 1183, Part C

Suitably, the ethylene/alpha-olefin copolymer wax of the present invention has a dynamic viscosity at 140° C. of 70 to 10,000 mPa·s, for example of 100 to 2,000 mPa·s or of 120 to 2,000 mPa·s, such as from 150 to 2,000 mPa·s. Any suitable method may be used to measure the dynamic viscosity, which methods are well known to a person skilled in the art.

Suitably, the ethylene/alpha-olefin copolymer wax of the present invention has a drop melting point of less than 112° C., for example of 83 to 105° C., as measured according to ASTM D 3954.

Suitably, the ethylene/alpha-olefin copolymer wax of the present invention has a hardness of 5 or above as measured according to DIN 51579. For example, the ethylene/alpha-olefin copolymer wax of the present invention may have a hardness of 5 to 75, for example of 5 to 35, as measured according to DIN 51579.

The ethylene/alpha-olefin copolymer wax of the present invention may have any suitable molecular weight. For example, the ethylene/alpha-olefin copolymer wax of the present invention may have a number average molecular weight less than 12,000 g/mol, for example less than 8,000 g/mol or less than 6,000 g/mol, as measured by size exclusion chromatography (SEC) using trichlorobenzene as the mobile phase. For example, the ethylene/alpha-olefin copolymer wax of the present invention may have a number average molecular weight at least 1,500 g/mol, for example at least 2,500 g/mol as measured by size exclusion chromatography (SEC) using trichlorobenzene as the mobile phase.

For example, the ethylene/alpha-olefin copolymer wax of the present invention may have a number average molecular weight from 1,200 to 12,000 g/mol, for example from 2,500 to 12,000 g/mol or from 2,500 to 6,000 g/mol, as measured by size exclusion chromatography (SEC) using trichlorobenzene as the mobile phase.

The number average molecular weight may be measured by size exclusion chromatography (SEC) at 160° C. in a PolymerChar GPC-IR. The mobile phase is trichlorobenzene (TCB), for example including 0.5 g/L butylhydroxytoluene at 1 mL/min. Heptane may be used as internal standard. 3 POLEFIN analytical linear columns may be used in series as the stationary phase. The detection may be conducted with a PolymerChar IR5 IR detector. The molar mass may be calculated from the elution volume with a polystyrene calibration standard (EasiCal PS-1). Typically, a double determination is conducted (for example from 12 mg samples in 6 mL TCB, dissolved at 160° C. for one hour under an inert atmosphere).

The ethylene/alpha-olefin copolymer wax of the present invention may comprise any suitable alpha-olefin. For example, the alpha-olefin of the copolymer may have greater than 3 carbon atoms or greater than 4 carbon atoms, such as from 5 to 16 carbon atoms. The alpha-olefin may be straight chain or branched. Examples of suitable alpha-olefins include 1-hexene, 1-octene and combinations thereof.

Preferably, the alpha-olefin is a straight chain alpha-olefin. Preferably, the alpha-olefin is a straight chain olefin and the copolymer is a branched copolymer. Preferably, the alpha-olefin is a straight chain olefin having 5 to 10 carbon atoms and the copolymer is a straight chain copolymer.

The ethylene/alpha-olefin copolymer wax of the present invention may comprise any suitable proportion of ethylene and alpha-olefin, i.e. so as to provide the desired properties of the copolymer wax. For example, the alpha-olefin may be present in the copolymer in an amount of at least 5 wt % with respect to the copolymer. The alpha-olefin may be present in the copolymer in an amount of 5 to 40 wt %, such as 15 to 40 wt %, for example 20 to 40 wt %, preferably 10 to 15 wt %, with respect to the copolymer.

Many known processes for preparing ethylene copolymers use transition metal catalysts. The ethylene/alpha-olefin copolymer waxes of the present invention may be prepared without the use of a transition metal catalyst, for example by means of a polymerization process that does not involve the use of a transition metal catalyst. Thus, the ethylene/alpha-olefin copolymer wax of the present invention may be substantially free of transition metal catalyst residue.

The ethylene/alpha-olefin copolymer wax of the present invention may have a density of 0.91 g/cm³ or less as measured at 20° C. according to DIN EN ISO 1183, Part C, a dynamic viscosity at 140° C. of 70 to 10,000 mPa·s, a drop melting point of less than 112° C., for example of 83 to 105° C., as measured according to ASTM D 3954 and a hardness of 5 or above as measured according to DIN 51579.

The ethylene/alpha-olefin copolymer wax of the present invention may have a density of 0.91 g/cm³ or less as measured at 20° C. according to DIN EN ISO 1183, Part C, a dynamic viscosity at 140° C. of 70 to 10,000 mPa·s, a drop melting point of 83 to 105° C., as measured according to ASTM D 3954 and a hardness of 5 to 75 as measured according to DIN 51579.

The ethylene/alpha-olefin copolymer wax of the present invention may have a density of 0.87 to 0.91 g/cm³ as measured at 20° C. according to DIN EN ISO 1183, Part C, a dynamic viscosity at 140° C. of 70 to 10,000 mPa·s, a drop melting point of less than 112° C., for example of 83 to 105° C., as measured according to ASTM D 3954 and a hardness of 5 or above as measured according to DIN 51579.

The ethylene/alpha-olefin copolymer wax of the present invention may have a density of 0.87 to 0.91 g/cm³ as measured at 20° C. according to DIN EN ISO 1183, Part C, a dynamic viscosity at 140° C. of 70 to 10,000 mPa·s, a drop melting point of 83 to 105° C., as measured according to ASTM D 3954 and a hardness of 5 to 75 as measured according to DIN 51579.

The ethylene/alpha-olefin copolymer wax of the present invention may have a density of 0.91 g/cm³ or less as measured at 20° C. according to DIN EN ISO 1183, Part C, a dynamic viscosity at 140° C. of 74 to 5944 mPa·s, a drop melting point of 83.7 to 101° C. as measured according to ASTM D 3954 and a hardness of 5 to 58 as measured according to DIN 51579.

The ethylene/alpha-olefin copolymer wax of the present invention may be prepared by any suitable process.

The ethylene/alpha-olefin copolymer waxes of the present invention may be prepared by a polymerization process.

According to a second aspect of the present invention, there is provided a process for preparing an ethylene/alpha-olefin copolymer wax having a density of 0.91 g/cm³ or less as measured at 20° C. according to DIN EN ISO 1183, Part C, comprising contacting the ethylene and the alpha-olefin under polymerization conditions at a temperature of from 220 to 290° C. and a pressure of at least 130 MPa.

The process of the second aspect of the invention may be conducted in any suitable reactor, such as a high pressure tubular reactor or a batch autoclave reactor.

Typically, the process of the second aspect of the present invention is a free radical polymerization. Thus, the process of the present invention is typically conducted in the presence of a suitable free radical polymerization initiator. Suitable free radical polymerization initiators include organic peroxides which function at temperatures in the range of 220 to 290° C. For example, suitable peroxide initiators include tert-butylperoxy-3,5,5-trimethylhexanoate, di-tert-butyl peroxide, tert-butyl peroxy-2-ethylhexanoate, didecanoyl peroxide, 2,5-dimethyl-2,5-di(2-ethylhexanoyl-peroxy)hexane, tert-amyl peroxy-2-ethylhexanoate, tert-butyl peroxydiethylacetate, tert-butyl peroxydiethylisobutyrate, 1,4-di(tert-butylperoxycarbo)cyclohexane as isomer mixture, tert-butyl perisononanoate, 1,1-di(tert-butylperoxy)-3,3,5-tri-methylcyclohexane, 1,1-di(tert-butylperoxy)cyclohexane, methyl isobutyl ketone peroxide, tert-butylperoxy isopropyl carbonate, 2,2-di(tert-butylperoxy)butane, tert-butyl peroxyacetate, di-tert-amyl peroxide, dicumyl peroxide, 2,5-dimethyl-2,5-di-tert-butylperoxyhexane, tert-butylcumyl peroxide, 2,5-dimethyl-2,5-di(tert-butylperoxy)-hex-3-yne, 1,3-diisopropyl monohydroperoxide, cumene hydroperoxide and tert-butyl hydroperoxide.

The process of the present invention may be conducted in the presence of a chain transfer agent. For example, suitable chain transfer agents include aldehydes and ketones, such as propionaldehyde or methyl ethyl ketone.

Typically, the process of the second aspect of the present invention is conducted in the absence of a metal catalyst (especially a metallocene or Ziegler-Natta catalyst). Typically, the process of the second aspect of the present invention is conducted in the absence of a chain transfer agent. Typically, the process of the second aspect of the present invention is conducted in the absence of a metal catalyst (especially a metallocene or Ziegler-Natta catalyst) and in the absence of a chain transfer agent. This advantageously provides high purity polymers that are useful in a range of applications.

According to a third aspect of the present invention, there is provided an ethylene/alpha-olefin copolymer wax obtained or obtainable by the process of the second aspect of the invention.

The ethylene/alpha-olefin copolymer wax of the first and third aspects of the present invention are useful in a wide variety of applications. For example, the waxes are useful as hot melt adhesives, and as viscosity or friction reducers.

The invention will now be further described with reference to the following non-limiting examples.

### EXAMPLES

The copolymer waxes of the examples were prepared using a polymerization reactor suitable for high pressure and high temperature, with mechanical stirring. The copolymerisation reactions were conducted at a pressure of about 150 MPa and a temperature of 220 to 240° C.

Copolymer parameters were measured according to the following methods:
Density: DIN EN ISO 1183, C (titration method—part C at 20° C.)
Drop melting point: ASTM D3954
Hardness: DIN 51579

Dynamic viscosity was measured at 140° C. using a MCR702e Modular Compact Rheometer (Anton Paar, Austria).

Number average molecular weight (Mn) was measured by size exclusion chromatography (SEC) using a PolymerChar GPC-IR (PolymerChar, Spain) with 3× POLEFIN linear columns (PSS Polymer, Germany) used in series as the stationary phase. The mobile phase was trichlorobenzene (TCB) containing 0.5 g/L BHT, eluted at 1 mL/min and 160° C. Detection was using an IR5 IR detector (PolymerChar, Spain) and Mn was calculated relative to EasiCal PS-1 polystyrene calibration standards (Agilent).

### Example 1

In Example 1, the monomers used were (i) ethylene and 1-hexene or (ii) ethylene and 1-octene, which monomers were used in the amounts shown in table 1.
Initiator: tert-butylperoxy-3,5,5-trimethylhexanoate

TABLE 1

| | | | Parameter | | | | | | |
|---|---|---|---|---|---|---|---|---|---|
| | | | | | | Hardness | | | |
| | | | | | | as Needle | | | |
| | | | | Density | Drop | penetration | | | |
| | | | | @20° C. | melting | value | | | |
| | | | Dynamic | [g/cm³] | point | [1 unit = | | DSC | DSC |
| | | | Viscosity | DIN EN | [° C.] | 0.1 mm] | | Melting | Melting |
| Monomer ratio by weight | | | @140° C. | ISO 1183 | ASTM | DIN | Mₙ | Peak | heat |
| Ethylene | 1-Hexene | 1-Octene | [mPas] | C | D3954 | 51579 | [g/mol] | [° C.] | [J/g] |
| 100% | — | — | 50-2000 | 0.92-0.95 | 110-120 | ≤5 | ≤10 | 112-122 | 130-160 |
| (comparative) | | | | | | | | | |
| 75.0% | 25.0% | — | 124 | 0.89 | 83.7 | 22 | 3640 | 83 | 100 |
| 80.0% | 20.0% | — | 132 | 0.89 | 91.4 | 12 | 4050 | 90.5 | 92 |
| 84.4% | 16.6% | — | 559 | 0.90 | 96.0 | 8 | | 93.3 | 136 |
| 88.9% | 11.1% | — | 1795 | 0.91 | 103.4 | 1 | | 98.5 | 152 |
| 66.6% | — | 33.3% | 74 | 0.88 | 85.0 | 58 | 2990 | 51.2 | 48 |
| 75.0% | — | 25.0% | 179 | 0.89 | 89.5 | 14 | 4420 | 89.2 | 82 |
| 80.0% | — | 20.0% | 730 | 0.90 | 94.9 | 11 | | 93.4 | 94 |
| 83.4% | — | 16.6% | 815 | 0.91 | 99.1 | 7 | 3920 | 98.5 | 117 |
| 85.7% | — | 14.3% | 166 | 0.91 | 101 | 5 | | 101.3 | 118 |
| 88.9% | — | 11.1% | 2961 | 0.91 | 105.5 | 1 | | 101.7 | 146 |

Table 1 shows that the ethylene/alpha-olefin copolymer waxes of the present invention have a density of 0.91 g/cm³ or less as measured at 20° C. according to DIN EN ISO 1183, Part C. The ethylene/alpha-olefin copolymer waxes of the present invention also have a dynamic viscosity at 140° C. of 74 to 5944 mPa·s, a drop melting point of 83.7 to 101° C. as measured according to ASTM D 3954 and a hardness of 5 to 58 as measured according to DIN 51579.

The present invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. An ethylene/alpha-olefin copolymer wax having a density of 0.91 g/cm³ or less as measured at 20° C. according to DIN EN ISO 1183, Part C.

2. The ethylene/alpha-olefin copolymer wax according to claim 1, wherein the density is from 0.87 to 0.91 g/cm³ as measured at 20° C. according to DIN EN ISO 1183, Part C

3. The ethylene/alpha-olefin copolymer wax according to claim 1, comprising a dynamic viscosity at 140° C. of 70 to 10,000 mPa·s.

4. The ethylene/alpha-olefin copolymer wax according to claim 1, further comprising a drop melting point of less than 112° C. as measured according to ASTM D 3954.

5. The ethylene/alpha-olefin copolymer wax according to claim 1, further comprising a hardness of 5 or above as measured according to DIN 51579.

6. The ethylene/alpha-olefin copolymer wax according to claim 1, further comprising a number average molecular weight less than 12,000 as measured according to size exclusion chromatography using trichlorobenzene as the mobile phase.

7. The ethylene/alpha-olefin copolymer wax according to claim 1, wherein the alpha-olefin of the copolymer has greater than 4 carbon atoms and up to 16 carbon atoms.

8. The ethylene/alpha-olefin copolymer wax according to claim 7, wherein the alpha-olefin of the copolymer comprises one or more of 1-hexene, 1-octene and combinations thereof.

9. The ethylene/alpha-olefin copolymer wax according to claim 1, wherein the alpha-olefin is present in the copolymer in an amount of at least 5 wt % with respect to the copolymer.

10. The ethylene/alpha-olefin copolymer wax according to claim 1, which is substantially free of transition metal catalyst residue.

11. A process for preparing an ethylene/alpha-olefin copolymer wax having a density of 0.91 g/cm³ or less as measured at 20° C. according to DIN EN ISO 1183, Part C, comprising contacting the ethylene and the alpha-olefin under polymerization conditions at a temperature of from 220 to 290° C. and a pressure of at least 130 MPa.

12. The process according to claim 11, which is a free radical polymerization.

13. The process according to claim 11, which is conducted in the absence of a metal catalyst.

14. The process according to claim 11 which is conducted in the absence of a chain transfer agent.
